(19) United States
(12) Patent Application Publication
(10) Pub. No.: US 2013/0325988 A1
(43) Pub. Date: Dec. 5, 2013

(54) PROFILE-BASED MESSAGE FILTERING AND DISTRIBUTION SYSTEM

(71) Applicants: Herbert Morewitz, II, Newport News, VA (US); Cory L Morewitz, Newport News, VA (US)

(72) Inventors: Herbert Morewitz, II, Newport News, VA (US); Cory L Morewitz, Newport News, VA (US)

(21) Appl. No.: 13/909,696

(22) Filed: Jun. 4, 2013

Related U.S. Application Data
(60) Provisional application No. 61/655,754, filed on Jun. 5, 2012.

(51) Int. Cl. H04L 12/58

(52) U.S. Cl. CPC H04L 51/12
USPC 709/206

(57) ABSTRACT

A server-based system filters and distributes messages based on a user-supplied profile. The server receives data messages from registered users and stores the data messages on data storage. Each data message is tagged with a profile identifier. The data storage also stores a user profile for each of the registered users. The server's processor selects ones of the data messages for distribution to selected ones of the registered users based on a correspondence between the data message's profile identifier and the stored user profiles.

Pursuant to 35 U.S.C. §119, the benefit of priority from provisional application 61/655,754, with a filing date of Jun. 5, 2012, is claimed for this non-provisional application.

### FIELD OF THE INVENTION

The invention relates generally to messaging systems, and more particularly to a system for controlling message distribution in which a user-specified location profile and/or interest profile are used to filter and distribute social messages and/or business-to-consumer messages that are to reach the user.

### BACKGROUND OF THE INVENTION

Smartphones and tablet computers have mobilized users of social media. FACEBOOK users can “post” text, photos and videos related to their current location and experience. TWITTER users can “tweet” their current thoughts, emotions, etc., related to events happening around them. In each case, a user's FACEBOOK “friends” or TWITTER “followers” can view the user's posts/tweets. These friends/followers are pre-existing and could be near the user. However, more often than not, the friends/followers are not near the user's location and/or event. That is, current forms of social media are predicated on communication with/to a pre-existing and set group of other users who may have zero interest in the posting/tweeting user's current situation. At the same time, there could be hundreds or thousands of other social media users who would be interested in the posting/tweeting user's current situation. Such interest could stem from being in proximity to the posting/tweeting user and the events being experienced thereby, or could stem from sharing an interest in the subject matter of the post/tweet. Unfortunately, current friend/follower-based social media does not allow such interested users to share in the post/tweet because they are not a friend/follower of the posting/tweeting user.

### SUMMARY OF THE INVENTION

Accordingly, it is an object of the present invention to provide a method and system for filtering and distributing social media messages based on a user-specified profile.

Another object of the present invention is to provide a method and system for filtering and distributing social messages and business-to-consumer messages based on a user-specified profile.

Still another object of the present invention is to provide a system and method of filtering and distributing social media messages based on a user's location and/or interests.

Other objects and advantages of the present invention will become more obvious hereinafter in the specification and drawings.

In accordance with the present invention, a server-based system filters and distributes messages based on a user-supplied profile as opposed to pre-existing relationships with other users. The server can receive and transmit data via the internet. The server includes a server processor and data storage accessed by the server processor. The server receives data messages from a plurality of registered users and stores the data messages on the data storage. Each data message is tagged with a profile identifier. The data storage also stores a user profile for each of the registered users. The server processor selects ones of the data messages for distribution to selected ones of the registered users based on a correspondence between the data message's profile identifier and the stored user profiles.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic view of an operational scenario used to carry out data message receipt, analysis, and distribution using a server in accordance with an embodiment of the present invention;

FIG. 2 is a screen shot of a menu screen that can be provided on a mobile device to set a radius for a moving region of sensitivity, to set a radius for a fixed region of sensitivity, and to set category tags used for data message analysis in accordance with an embodiment of the present invention;

FIG. 3 is a schematic view of an operational scenario for a server-based system for profile-based message filtering and distribution in accordance with an embodiment of the present invention;

FIG. 4 is a schematic view of the server-based system illustrating the handling/processing of data messages in accordance with an embodiment of the present invention;

FIG. 5 is a schematic view of the server-based system illustrating the distribution of data messages in accordance with an embodiment of the present invention; and

FIG. 6 is a schematic view of the server-based system illustrating the establishment of threads for data messages and their replies in accordance with another embodiment of the present invention.

### DETAILED DESCRIPTION OF THE INVENTION

In general, the present invention is a server-based system for filtering and distributing messages based on user-supplied profile data. The present invention will allow users of mobile devices to share data messages (e.g., text, photos. videos, audio, etc.) with other users of mobile devices when no previous relationship exists. Instead, the present invention will allow users to share such data when user-supplied profile data corresponds to one or more profile identifiers that are “tagged” to each data message.

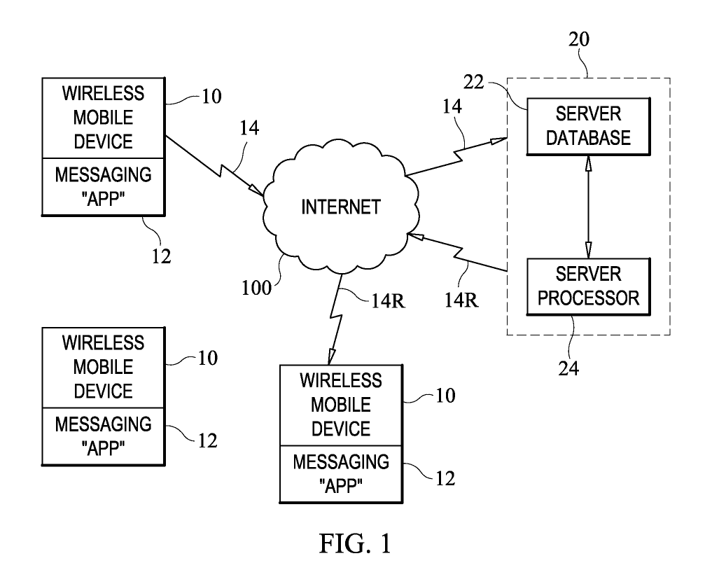

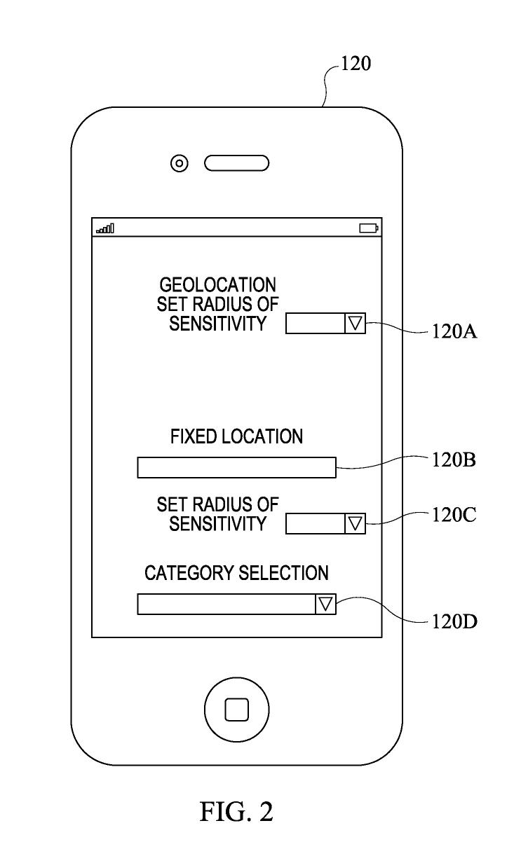

Prior to describing the server-based system in detail, an overview of the general operation of the present invention will be described with the aid of FIGS. 1 and 2. FIG. 1 illustrates an operational scenario using a server in accordance with the present invention. A number of wireless mobile devices 10 are assumed to be authorized or registered users of a profile-based message filtering and distribution system made possible by the present invention. Examples of wireless mobile devices include, but are not limited to, smartphones, tablet devices (e.g., IPAD, SAMSUNG GALAXY, Hewlett Packard's Touch Pad, etc.), or any other mobile device capable of accessing and sending data over the internet 100, i.e., supporting bi-directional communication with the internet 100 as is well understood in the art. Accordingly, each illustrated mobile device 10 is provided (e.g., via download) with a messaging application 12 (or “app” as it will be referred to hereinafter) by virtue of such authorized use. Typically and as is known in the art, mobile devices 10 will be equipped with a GPS receiver and the capability to determine their own geolocation via GPS signals. While the illustrated example will be described for users of wireless mobile devices, the present invention is not so limited. That is, other devices capable of communicating over the internet could be utilized in place of, or in addition to, wireless mobile devices 10. Such other devices include desktop computers and laptop computers.

Messaging app 12 would generally require some initial set-up information from each user of mobile devices 10. Such set-up information generally includes a user name, password, and “user profile” information that could include location(s) of interest to that particular user and/or one or more of category tags that identify subject(s) of interest to that particular user. A “category” as used herein can be a single broad category (e.g., news, events, etc.), or could be narrowed using a category/sub-category tag (e.g., news/local, news/national, events/sports, events/art, etc.). Categories could be pre-defined in/by messaging app 12 to simplify processing at server 20 as will be described further below. The set-up information is delivered to a dedicated server 20 via the internet 100 where such information is stored in and accessed from a server database 22 by a server processor 24.

For purpose of the illustrative example, it is further assumed that the illustrated mobile devices 10 are registered users of the message filtering/distribution system and can communicate bi-directionally with server 20 via the internet 100. For clarity of illustration, “lines” illustrating such bi-directional communication have been omitted. It is further assumed in the illustrated example that one mobile device 10 has generated a data message 14 having category tags and a geo tag (i.e., a geolocation generated by mobile device 10 as is known in the art) appended thereto or included therewith. Message 14 is delivered to server 20 via the internet 100. Processor 24 stores each such message 14 in database 22 and performs periodic analysis/procedures on/using the received/stored messages in conjunction with stored user profile information for registered users.

Messaging app 12 gives a user the ability to define parameters that determine which ones of messages stored at server 20 will be distributed thereto. The user-defined parameters can be based not only on specifically-selected category tags, but additionally or alternatively on proximity of the user's mobile device 10 to the GPS location associated with the origination of message 14. That is, messaging app 12 can give a user the ability to define a sensitivity radius or region surrounded by the geolocation of the user's mobile device 10 such that message 14 will only be distributed to users whose sensitivity region encompasses the geolocation where message 14 originated. Such radius/region selection can be made via a drop down menu or manual entry as would be well understood in the art. Additionally or alternatively, messaging app 12 can give a user the ability to select certain ones of server-stored messages based on the category tags associated with message 14. In this way, the user of mobile device 10 can customize the receipt of messages in a way that limits received messages to those that are most relevant to the user's location, needs, desires, etc.

Messaging app 12 can be configured to provide a user with the ability to define multiple regions of sensitivity. For example, a screen shot menu 120 (generated by app 12) is presented on a user's mobile device 10 as illustrated in FIG. 2. Menu 120 allows the user to define a radius of sensitivity (e.g., via a drop down menu 320A) associated with the mobile device's geolocation. The resulting region of sensitivity will move with the device's current geolocation. App 12 could also allow the user to enter a home address (e.g., residence, office, event location, etc.) at 120B and a corresponding radius of sensitivity via drop down menu 120C. This will result in a fixed region of sensitivity based on the particular address entered at 120B. Screen shot menu 120 could simultaneously provide a category tag selection option via a drop down menu 120D. Another option is for a user to enter his/her own category identifier and then allow server 20 to analyze the user's category identifier and assign it to a particular pre-defined category within server 20. In either case, the category option allows a user to easily customize/limit receipt of server-stored messages to subject areas of interest at any given time. When both region(s) of sensitivity and subject matter areas of interest are defined, a user will only have messages distributed thereto when there is correspondence between the user's profile and the identifier information associated with message 14.

As mentioned above, processor 24 implements one or more algorithms to perform periodic (e.g., every few seconds) analysis and procedures using received/stored messages (e.g., message 14) and stored user profile information for currently registered users (e.g., the users of the illustrated mobile devices 10 in FIG. 1). The goal of the algorithms and procedures is to distribute any of the stored messages (e.g., message 14) to ones of mobile devices 10 whose user profile information (that can include region(s) of sensitivity and/or category(ies) of interest) indicates that message 14 is of interest. The distributed message is indicated in the figures as message 14R.

Algorithms and procedures implemented by processor 24 can be simple (e.g., based purely on location correspondence, purely on category tag correspondence, or a combination of location and category tag correspondence), or more sophisticated (e.g., intelligence-based) such that location, category tags, time of day, etc., correspondence are taken into consideration when determining if a message should be delivered/distributed to a particular user. Furthermore, processor 24 could implement a global message relevance based on time. For example, data messages could be purged from server 20 based on a window of time (e.g., hours, days, etc.) that extends from the current time to some previous time. This will maintain data message relevance stored/distributed by server 20, while also reducing storage requirements for server 20. Still further, a user-supplied category tag could identify a time window thereby allowing a user to control message distribution thereto based on the user's time relevance preference. It is also to be understood that processor 24 could arrange for the distribution of data messages (satisfying correspondence criteria) to all registered users “known” to server 20, or just to registered users known by server 20 and currently “active” (e.g., mobile device is turned on and messaging app is activated) without departing from the scope of the present invention.

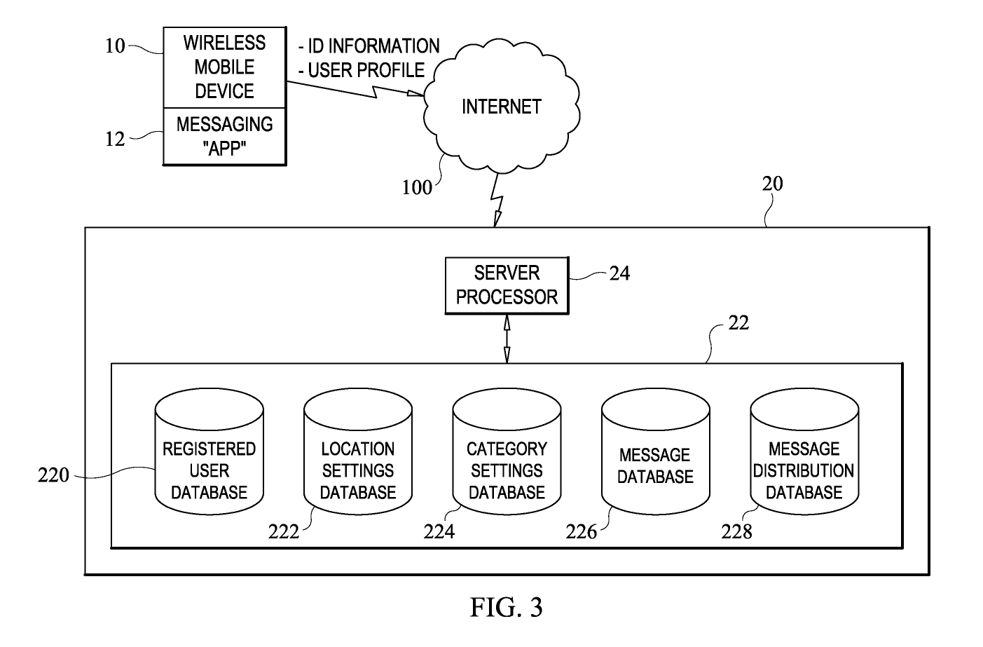

Referring now to FIG. 3, the profile-based message filtering and distribution system of the present invention embedded in server 20 is shown in greater detail. As mentioned above, server 20 is capable of receiving data and transmitting data via the internet 100. As used herein, the word “data” and the phrase “data message” can include text messages, still images, video images, data files, audio signals, hyperlinks, and combinations thereof. Transfer protocols related to transfer of data and data messages over the internet 100 are well understood in the art and are not limitations of the present invention.

Server 20 can be any conventional server hardware that generally includes data storage 22 and server processor 24 as would be understood by one of ordinary skill in the art. Accordingly, it is to be understood that the choice of server is not a limitation of the present invention. Processor 24 provides the processing platform for receiving all incoming data messages from registered users and for controlling the selective distribution of certain ones of the data messages based on the profiles of the registered users as will be explained further below. Data storage 22 and processor 24 could be incorporated in server 20 or could be a separate hardware/software system(s) without departing from the scope of the present invention.

As described above, the content of the data handled by server 20 originates from one or more registered users communicating with server 20 (over the internet 100) using mobile wireless devices 10 (or other internet-communication-capable devices). Data could also be supplied to server 20 via a dedicated website accessing server 20. It is assumed that each user of a mobile device 10 (or other device accessing server 20) referenced herein is a registered user recognized by server 20. Server 20 includes a number of databases (e.g., separate databases or a single database parsed into a number of database structures) for performing its message filtering and distribution operations.

Registration is accomplished when the user of mobile device 10 provides unique identification (“ID”) information (e.g., e-mail, username, password, etc.) to server 20. Registration can be accomplished through messaging app 12 or from a dedicated website accessing server 20. Processor 24 populates a registered user database 220 with the user-supplied unique identification information. Prior to doing so, processor 24 performs checks on this information to assure that there is no duplicate registered user in database 220. The identification information collected/stored can also include information provided automatically by mobile device 10. Such information can include device type and configuration, the device's current geolocation, etc.

Once the user is a “registered user” in the eyes of server 20, the user can provide user profile information to include one or more locations/regions of interest and, additionally or alternatively, one or more (subject matter) categories of interest. In terms of location, the user supplies a radius (e.g., via menu at device 10) that is used by processor 24 to define a region surrounding the current geolocation of the user's device 10. This region moves with device 10 and is constantly updated by server 20. Therefore, a user can adjust the size of the region to increase/decrease sensitivity to message distribution since server 20 will filter/distribute only these data message originating within the device's defined moving region. An additional feature that can be provided by the present invention is the option to provide a fixed location and corresponding radius of sensitivity. The fixed location could be one's home address, business address, address of a business establishment, an event venue, etc. The fixed location/region is used by server 20 to filter/distribute only those data messages originating within the user-defined fixed region. Additional fixed location/region definitions could be made available to the user without departing from the scope of the present invention. The moving region and (optional) fixed region(s) are stored in a user location settings database 222 to thereby identify (for server 20) all registered users that are currently logged on.

Additionally or alternatively, the registered user of device 10 can provide user profile information related to one or more subject matter categories of interest. The user profile related to category(ies) is stored in a user category settings database 224 that can be updated/changed at any time by a registered user. The possible categories could be predetermined by messaging app 12 and presented on device 10 in the form of a menu. As mentioned above, a category can be broad or can be narrowed using a category/sub-category definition. In addition, a category can identify an originator of a data message such as a restaurant, a sports team, etc., who sends out data messages that are essentially commercial advertisements. In this way, a user can filter messages originating from certain businesses of interest. When a category user profile is combined with the above-described location user profile, the present invention allows the registered user to have data messages distributed thereto based on the combination of the messages' origination in a location of interest and content associated with a category(ies) of interest.

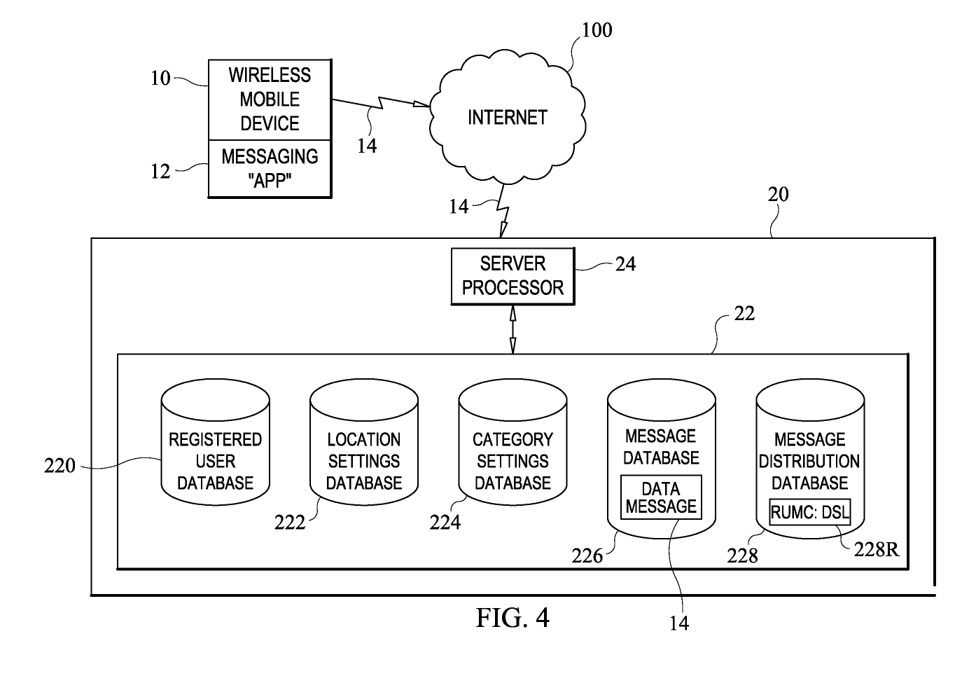

The handling/processing of data messages by server 20 will now be described with the aid of FIG. 4. For a location-only-based identifier, a data message 14 is automatically tagged with the geolocation of device 10 at the time data message 14 is transmitted. For a category-only-based identifier, the user selects the category that will be tagged to data message 14 when it is transmitted. For a location-and-category-based identifier, the user selects the category that will be tagged to data message 14 and data message 14 is additionally tagged with the geolocation of device 10 at the time of message transmission. By way of an illustrative example, it will be assumed that data message 14 is tagged with a geolocation and category identifiers when it is transmitted.

When server 20 receives data message 14, processor 24 authenticates the transmitting user by accessing registered user database 220. Assuming the user in authenticated, processor 24 stores data message 14 in a message database 226 and records its storage location. This procedure is duplicated for every incoming data message from any authenticated registered user.

Processor 24 uses the location/category identifiers tagged to data message 14 and searches databases 222 and 224 for correspondence (e.g., exact matches, approximate matches using intelligence-based algorithms, etc.) with other user profile location/region definitions and user profile category definitions in databases 222 and 224, respectively. When processor 24 finds correspondence, the identity(ies) of those registered user(s) is used to populate a message distribution database 228. Specifically, each data record 228R in database 228 includes the identity of a registered user with message correspondence (or “RUMC”) with a data storage location (“DSL”) in database 226 of the data message (e.g., data message 14) that generated such correspondence. Thus, database 228 represents a filtered set of data records that identify data messages ready for distribution.

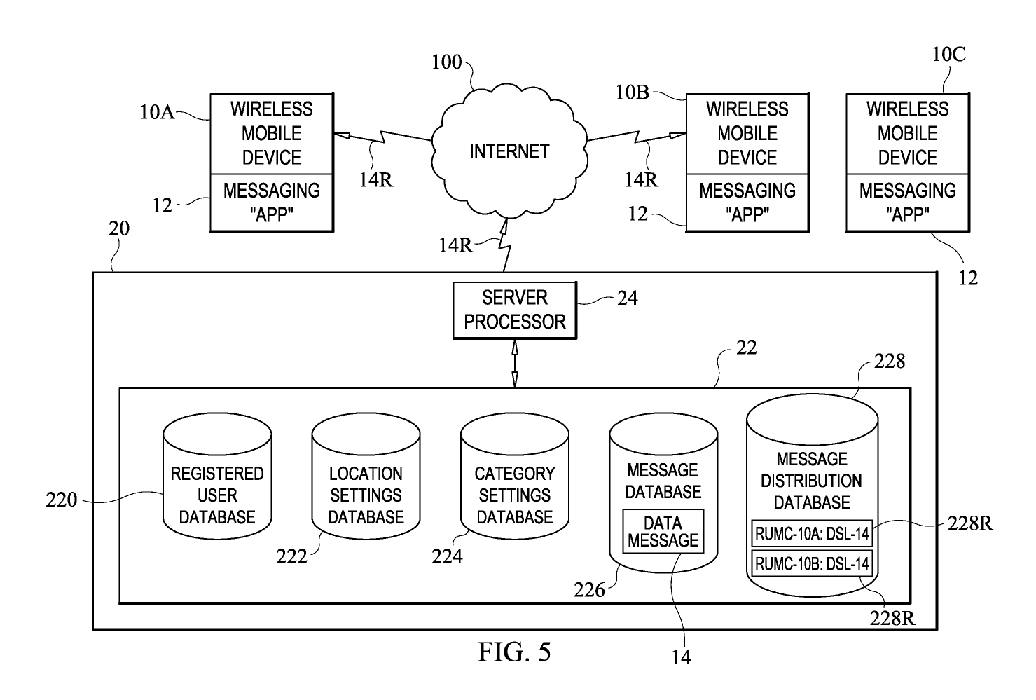

Referring now to FIG. 5, distribution of data messages identified in database 228 will be described. Once again, the distribution of a single data message (e.g., data message 14) as data message 14R will be used to describe the operation of the server-based system. It is assumed that additional registered users in possession of mobile devices 10A, 10B and 10C have been authenticated by server 20. In the illustrated example, it is further assumed that users of devices 10A and 10B have user profiles that provided correspondence with the identifiers tagged to data message 14, while the user's profile associated with device 10 did not yield such correspondence. Accordingly, during the search for correspondence by processor 24, database 228 is populated with records 228R, one of which includes identity RUMC-10A (for the user of mobile device 10A) and the other includes identity RUMC-10B (for the user of mobile device 10B). The data storage location DSL-14 of data message 14 is included in each data record 228R. At message distribution, only the users of mobile device 10A and 10B will receive data message 14R as illustrated in FIG. 5.

Server 20 controls distribution of data message 14R by either a “push” or “pull” process. If server 20 is to push data messages 14R, server 20 will constantly or periodically transmit data message 14R over the internet 100. If server 20 is to distribute data message on a pull basis, server 20 will distribute data message 14R to individual identified registered users in database 228 when a user's mobile device (or other device being used by the registered user) requests such delivery. Such push or pull delivery methods are known in the art.

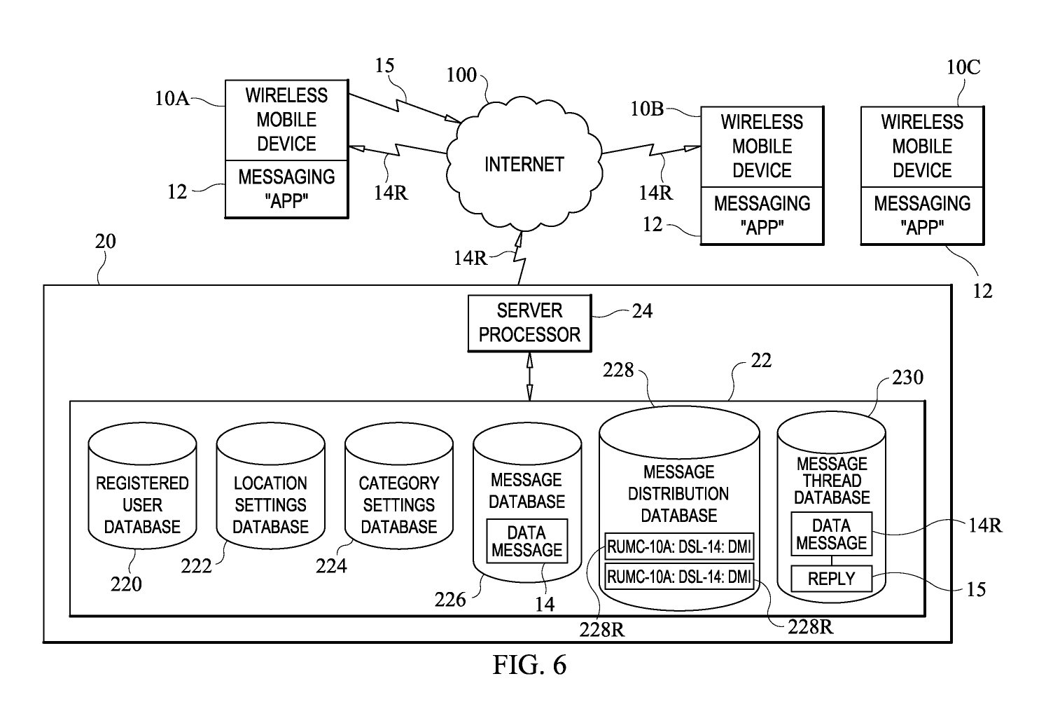

The server-based system of the present invention can further include the capability to maintain a thread that starts with a distributed data message and builds with a series of replies. This capability is illustrated and will be described operationally with the aid of FIG. 6. When processor 24 distributes data message 14R, a distributed message identification (“DMI”) is tagged thereto. If either (or both) of users of mobile devices 10A and 10B replies to data message 14R, processor 24 populates a message thread database 230. For example, assume user of mobile device 10A replied to data message 14R with a data message 15, processor 24 populates database 230 with the originating data message 14R and all subsequent replies such as data message 15. The reply data message 15 could be sent to the originator of data message 14R. The process is repeated for multiple responders to the originally-distributed data message. While a separate database 230 is shown for this purpose, it is to be understood that message threads could also be generated by updating the appropriate ones of data records 228R in database 228 with replies.

The advantages of the present invention are numerous. Registered users of the server-based system of the present invention can receive data messages from other users without any pre-existing relationships therewith. Rather, the present invention allows registered users to share information, experiences, etc., with other similarly located users and/or users with similar interests. No “friend” or “follower” relationships need to be established or built. The present invention allows a user to tailor the filtering and distribution of social or commercial data messages to his/her location and/or interest preferences.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A server-based system for filtering and distributing messages based on a user-supplied profile, comprising:
a server adapted to receive and transmit data via the internet, said server including a server processor and data storage accessed by said server processor;
said server adapted to receive data messages from a plurality of registered users and storing said data messages on said data storage, each of said data messages tagged with a profile identifier;
said data storage storing a user profile for each of said plurality of registered users; and
said server processor selecting ones of said data messages for distribution to selected ones of said plurality of registered users based on a correspondence between said profile identifier and said user profile.

2. A server-based system as in claim 1, wherein said profile identifier includes a geolocation where a corresponding one of said data messages originated, and wherein said user profile includes at least one geographic region of interest.

3. A server-based system as in claim 1, wherein said profile identifier includes a subject category identifying a general subject matter of a corresponding one of said data messages, and wherein said user profile includes at least one subject category of interest.

4. A server-based system as in claim 1, wherein said profile identifier includes:
a geolocation where a corresponding one of said data messages originated; and
at least one of a subject category identifying a general subject matter of said corresponding one of said data messages and an originator of said corresponding one of said data messages.

5. A server-based system as in claim 2, wherein said at least one geographic region of interest comprises:
a first geographic region surrounding a fixed geolocation; and
a second geographic region surrounding a moving geolocation.

6. A server-based system for filtering and distributing messages based on a user-supplied profile, comprising:
a server adapted to receive and transmit data via the internet, said server including a server processor and data storage accessed by said server processor;
said data storage defining a plurality of database structures to include a profile database, a data message database, and a data message delivery database;
said server processor populating said profile database with a plurality of registered user identities and corresponding user-supplied profile criteria, each of said registered user identities being associated with a unique one of a plurality of registered users;
said server processor populating said data message database with data messages transmitted to said server from ones of said plurality of registered users, each of said data messages being tagged with a profile identifier;
said server processor comparing each said profile criteria with each said profile identifier wherein, for each correspondence therebetween, said server processor populates said data message delivery database with a corresponding one of said registered user identities and a storage location of a corresponding one of said data messages stored in said data message database; and
said server processor distributing said data messages identified in said data message delivery database to ones of said registered users associated therewith.

7. A server-based system as in claim 6, wherein said profile identifier includes a geolocation where a corresponding one of said data messages originated, and wherein said profile criteria includes at least one geographic region of interest.

8. A server-based system as in claim 6, wherein said profile identifier includes a subject category identifying a general subject matter of a corresponding one of said data messages, and wherein said profile criteria includes at least one subject category of interest.

9. A server-based system as in claim 6, wherein said profile identifier includes:
a geolocation where a corresponding one of said data messages originated; and
at least one of a subject category identifying a general subject matter of said corresponding one of said data messages and an originator of said corresponding one of said data messages.

10. A server-based system as in claim 7, wherein said at least one geographic region of interest comprises:
a first geographic region surrounding a fixed geolocation; and
a second geographic region surrounding a moving geolocation.

11. A server-based system as in claim 6, said server processor distributes said data messages identified in said data message delivery database to ones of said registered users associated therewith based on requests made to said server processor.

12. A server-based system as in claim 6, said server processor initiates distribution of said data messages identified in said data message delivery database to ones of said registered users associated therewith.

13. A server-based system for filtering and distributing messages based on a user-supplied profile, comprising:
a server adapted to receive and transmit data via the internet, said server including a server processor and data storage accessed by said server processor;
said data storage defining a plurality of database structures to include a profile database, a data message database, and a data message delivery database;
said server processor populating said profile database with a plurality of registered user identities and corresponding user-supplied profile criteria to include at least one geographic region of interest, each of said registered user identities being associated with a unique one of a plurality of registered users;
said server processor populating said data message database with data messages transmitted to said server from ones of said registered users, each of said data messages being tagged with a profile identifier to include at least a geolocation where a corresponding one of said data messages originated;
said server processor comparing each said profile criteria with each said profile identifier wherein, for each correspondence between said one geographic region of interest and said geolocation, said server processor populates said data message delivery database with a corresponding one of said registered user identities and a storage location of a corresponding one of said data messages stored in said data message database; and
said server processor distributing said data messages identified in said data message delivery database to ones of said registered users associated therewith.

14. A server-based system as in claim 13, wherein said profile identifier includes a subject category identifying a general subject matter of a corresponding one of said data messages, and wherein said profile criteria includes at least one subject category of interest.

15. A server-based system as in claim 13, wherein said profile identifier further includes at least one of a subject category identifying a general subject matter of said corresponding one of said data messages and an originator of said corresponding one of said data messages.

16. A server-based system as in claim 13, wherein said at least one geographic region of interest comprises:
a first geographic region surrounding a fixed geolocation; and
a second geographic region surrounding a moving geolocation.

17. A server-based system as in claim 13, said server processor distributes said data messages identified in said data message delivery database to ones of said registered users associated therewith based on requests made to said server processor.

18. A server-based system as in claim 13, said server processor initiates distribution of said data messages identified in said data message delivery database to ones of said registered users associated therewith.

19. A server-based system for filtering and distributing messages based on a user-supplied profile, comprising:
a server adapted to receive and transmit data via the internet, said server including a server processor and data storage accessed by said server processor;
said data storage defining a plurality of database structures to include a profile database, a data message database, and a data message delivery database;
said server processor populating said profile database with a plurality of registered user identities and corresponding user-supplied profile criteria to include at least one subject category of interest, each of said registered user identities being associated with a unique one of a plurality of registered users;
said server processor populating said data message database with data messages transmitted to said server from ones of said plurality of registered users, each of said data messages being tagged with a profile identifier to include a subject category identifying a general subject matter of a corresponding one of said data messages;
said server processor comparing each said profile criteria with each said profile identifier wherein, for each correspondence between said subject category of interest and said subject category identifying a general subject matter, said server processor populates said data message delivery database with a corresponding one of said registered user identities and a storage location of a corresponding one of said data messages stored in said data message database; and
said server processor distributing said data messages identified in said data message delivery database to ones of said registered users associated therewith.

20. A server-based system as in claim 19, wherein said profile identifier includes a geolocation where a corresponding one of said data messages originated, and wherein said profile criteria includes at least one geographic region of interest.

21. A server-based system as in claim 19, wherein said profile identifier includes:
a geolocation where a corresponding one of said data messages originated; and
at least one of said subject category identifying a general subject matter of said corresponding one of said data messages and an originator of said corresponding one of said data messages.

22. A server-based system as in claim 20, wherein said at least one geographic region of interest comprises:
a first geographic region surrounding a fixed geolocation; and
a second geographic region surrounding a moving geolocation.

23. A server-based system as in claim 19, said server processor distributes said data messages identified in said data message delivery database to ones of said registered users associated therewith based on requests made to said server processor.

24. A server-based system as in claim 19, said server processor initiates distribution of said data messages identified in said data message delivery database to ones of said registered users associated therewith.
